(19) United States
(12) Patent Application Publication
(10) Pub. No.: US 2006/0282989 A1
(43) Pub. Date: Dec. 21, 2006

(54) Magnetic instrument holder

(76) Inventor: Dan L. Dietz, Houston, TX (US)

Correspondence Address: Darcell Walker, Suite 250, 9301 Southwest Freeway, Houston, TX, 77074, US

(21) Appl. No.: 11/157,048

(22) Filed: Jun. 20, 2005

(51) Int. Cl. B43K 25/00

(52) U.S. Cl. 24/10 R

(57) ABSTRACT

A magnetic pocket pouch is designed to attach to the pocket of a clothing item. The magnetic pocket pouch has front side, a backside and an extension from the backside capable of folding either forward or backward. When folded in a forward or closed position, the pocket pouch fits inside the pocket of a clothing item. Magnets on the front side and the extension connect to close and secure the outer side of the pocket between the front side and extension of the pouch thereby securing the pouch to the pocket of the clothing item. The extension also folds back in an open position. In this position, magnets on the extension and backside of the pouch connect and secure the outer wall of the clothing item pocket between the backside and extension of the pouch. In the closed position, the pouch hangs outside the pocket of the clothing item.

### FIELD OF THE INVENTION

This invention relates to a device for securing writing or other instruments on a person's clothing and in particular, this invention relates to a magnetic pouch for containing such instruments that securely engages a pocket on the clothing of an individual. This engagement of the individual's clothing secures the magnetic pouch to the individual. The magnetic pouch has the capability of holding one or more writing instruments.

### BACKGROUND OF THE INVENTION

Written communications have been a primary means of communication dating back to the medieval period. As early as the 4^{th} century, people used crude writing instruments to communicate information. These instruments consisted of hollow straws or reeds that supported a short column of liquid. During the fifth century, people began to make pens formed from wing feathers. Currently, the writing pen has evolved into a variety writing instruments, which include: the ballpoint pen, the fountain pen, the soft-tip pen lettering pin and the technical pin. Today, pens rank among the most widely used writing instrument.

Writing instruments have also contained clips used to secure the instrument to the clothing of the user. U.S. Pat. No. 5,152,626 describes a writing instrument that includes a clip, which can be retracted into an opening of a barrel, and an operating unit, which has a pushbutton and an operating cam. The writing instrument can be operated by a single operating means, while the clip can function only when the writing cartridge is retracted.

U.S. Pat. No. 6,685,374 describes a spring biased clip design. This clip assembly is securably affixable to the body of a variety of hand-held implements, including writing devices, which is capable of clasping objects substantially thicker that a garment pocket, such as notepads, books, and backpacks. The clip assembly comprises a pin securably engaged to the body of the hand-held implement, a rigid member having a first end for clasping an article, and a second end for manually operating the clip assembly, and a spring biasing the first end of the rigid member towards the body of said hand-held writing implement.

U.S. Pat. No. 6,499,196 describes a clip for a writing instrument has an external biasing mechanism separate from the connection of the clip to the writing instrument to avoid permanent deformation or breaking of the clip arm and wear on the writing instrument body. The biasing mechanism is a coil spring mounted on the clip arm between two supports for compression and flexion when the clip arm is pulled away from the side of the writing instrument.

Another conventional method to support writing instruments is to contain these instruments in a pouch. Writing instruments such as pens and pencils are usually supported in open top or patch pockets in shirts, jackets and other clothing items. These pouches are usually secured to the pocket by a metal clip attached to the pocket or by an extension of the pouch that extends into the pocket while the pouch hangs in front of the pocket. With the flap design, the flap inside the pocket serves as a counter balance to the weight of the writing instruments in the pouch. A disadvantage of a conventional pouch having a metal clip is that it can be difficult to insert the clip over the edge of the pocket and to remove it from the edge when needed. A disadvantage of both the metal and clip and flap extension designs is that the weight of the pouch containing the writing instruments pulls the material of the pocket out of shape which results in damage to the pocket and an untidy appearance.

U.S. Pat. No. 3,178,784 attempts to address these disadvantages with a magnetic pocket pencil holder device. This device provides a magnetic support of the writing instruments such that it is not necessary to use spring-loaded clips engageable over the edge of the pocket. With this invention, a bendable V-shaped metal plate is placed over a pocket such that one side of the plate is inside the pocket and the other side is outside the pocket. The outside portion of the plate covers the pocket. Since this plate is metal, it receives and holds a permanent magnet attached to a writing instrument thereby securing the writing instrument to the pocket. Although this invention is an attempt to address the problems of the conventional pouch for containing writing instruments, this approach also has disadvantages.

There remains a need for a pouch device that can adequately hold one or more writing instruments with adverse effects to the clothing items containing a pocket that supports the writing instruments.

### SUMMARY OF THE INVENTION

It is an objective of the present invention to provide a magnetic pocket pouch for holding writing instruments.

It is a second objective of the present invention to provide a magnetic pocket pouch that can hold writing instruments inside the pocket.

It is a third objective of the present invention to provide a magnetic pocket pouch that can hold writing instruments outside the pocket.

It is a fourth objective of the present invention to provide a magnetic pocket pouch that can sufficiently secure magnetic instruments within the pouch.

It is a fifth objective of the present invention to provide a magnetic pocket pouch that can be secured to a pocket of a clothing item inside or outside of the pocket.

The present invention provides a pouch for holding writing instruments. This pouch comprises a material such as leather shaped in the form of a pocket. This pouch pocket has a front side and a backside that connect to form the pocket. An extension is attached to the backside extends upward a length greater than the upward length of the front side. The length of this extension should be such that the top portion of the back side can either fold back for insertion into the pocket of the clothing article or fold forward over the front side of the pouch. A flexible material can be incorporated into the backside of the pouch to facilitate the folding operation of the pouch. Magnetic components are attached to the outer surfaces of the front side and the backside. In addition, magnets are also attached to both sides of the extension. The extension magnets are positioned such that when folded forward, the outer magnet of the extension will align with the magnet of the front side. The inner magnet of the extension is positioned to align with the magnet of the backside when the extension is folded backward.

In addition to these magnets, the present invention can have a magnet component attached to the front side and near the top. This magnet can have a bar shape such that it extends horizontally across a large portion of the front side. This horizontal magnet can serve as an attaching means for magnet based writing instruments stored in the pocket pouch. This magnet attaching means further secures these magnetic based writing instruments to the pouch pocket when the pouch is folded in either the front or backward positions.

### DESCRIPTION OF THE DRAWINGS

FIG. 1 is a front view of the magnetic pocket pouch of the present invention.

FIG. 2 is a side view of the magnetic pocket pouch of the present invention.

FIG. 3 is a front, top and side view of the magnetic pocket pouch of the present invention with the extend member in a folded back or open position.

FIG. 4 is a side view of the magnetic pocket pouch of the present invention shown the extension member in the folded back or open position.

FIG. 5 is a back, top and side view of the magnetic pouch of the present invention with the extension member in the folded back or open position.

FIG. 6 is a front, top and side view of the magnetic pocket pouch of the present invention with the extend member in a forward folded or closed position.

FIG. 7 is a side view of the magnetic pocket pouch of the present invention shown the extension member in the forward folded or closed position.

FIG. 8 is a back, top and side view of the magnetic pouch of the present invention with the extension member in the forward folded or closed position.

FIG. 9 is a front, top and side view of the magnetic pocket pouch of the present invention with the extend member in a back folded or open position and showing the horizontal magnet attached to the front side of the pocket pouch.

FIGS. 10a, 10b, 10c and 10d show side, three-quarter, back, front, and side views of a magnetic clip that attaches to the magnetic pocket pouch for clipping the pouch to other objects such as an automobile visor.

FIGS. 11a, 11b and 11c show back, side and three-quarter views of the magnetic clip attached to the magnetic pouch in the closed position.

FIGS. 12a, 12b and 12c show front, side and three-quarter views of the magnetic clip attached to the magnetic pouch in the open position.

### DETAILED DESCRIPTION OF THE INVENTION

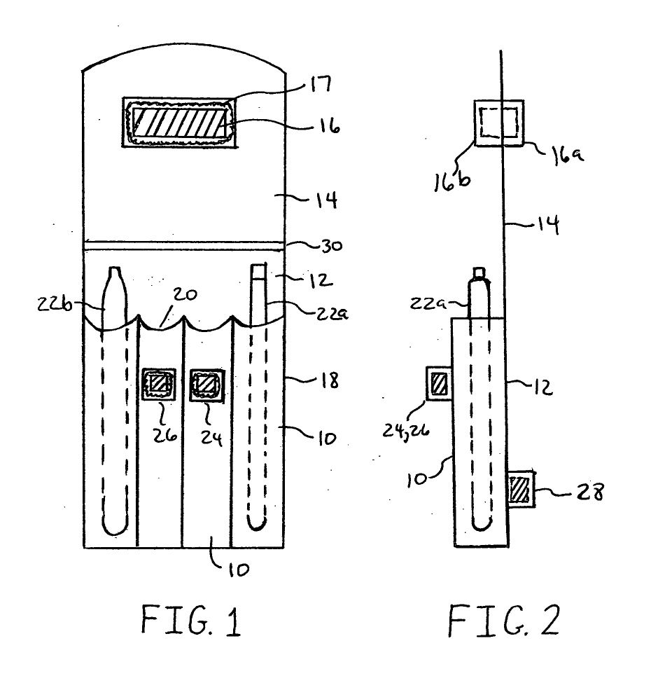

FIG. 1 illustrates basic concept of the present invention. As shown, this device is a pocket pouch with a front side 10, a backside 12, and an extension 14. The front and back sides can be of a flexible but durable material. These materials that comprise this pouch can comprise leather, various cloths or various plastic materials. A magnet 16 attaches to the extension 14. The extension has an inner side 14a and an out side 14b. FIG. 2 shows the magnet 16 being attached to both sides of the extension such that the magnet is exposed on both sides of the extension. The magnet 14 can be one magnet extending through the extension or there can be two magnets. With the two-magnet design, one magnet would be on each side of the extension. The front side 10 and the backside 12 form the pocket by attaching at the edges 18 of both the front and backsides. Sown stitching 17 is one means to attach the edges of both sides to form the pocket. Magnet 16 can also be sown into the extension 14. The magnet 16 can be a two component magnet 16a and 16b as shown in FIG. 2.

In this embodiment, the pouch can have separate compartments 20 to hold individual instruments 22a and 22b that are placed in the pouch. The type of instrument in the pouch can vary and can include instruments such as writing pens, writing pencils and flashlights. One such instrument can be a writing instrument with a magnetic clip as described in U.S. Patent application Ser. No. 10/907734 and shown as 22a. Another instrument include could be magnetic flashlight such as the one described in U.S. Patent application Ser. No. 10/908108 indicated as 22b. Magnets 24 and 26 attach to the front side of the pouch. These magnets are positioned such that the magnet 16 will contact them when the extension is folded forward. Referring to FIG. 2, magnet 28 is positioned on the backside such that the magnet contacts the magnetic 16 when the extension folds backward into the open position. All of these magnets 24, 26, and 28 can be attached by stitching similar to magnet 16. As seen, the present invention can include a bend section 30 to help facilitate the bending of the extension in a front or back direction. This bend can just be a part of the extension and comprise the same material or it can be a different material that connects the backside and the extension. In this invention, bending operations can be either open or closed. The bending actions can be in either direction. Bending in both directions shortens the life of the material. Therefore, the material must be able to endure this type of bending activity without breaking and coming apart.

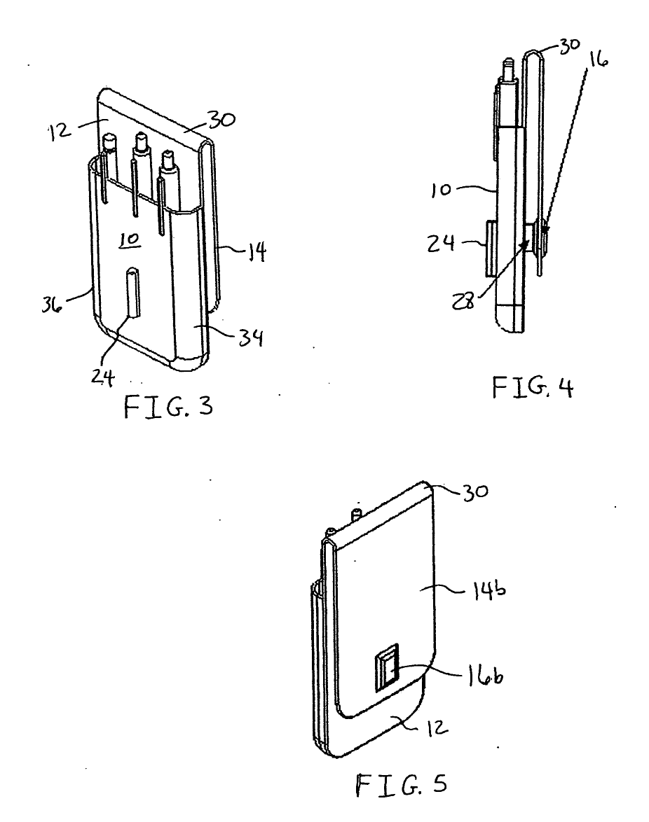

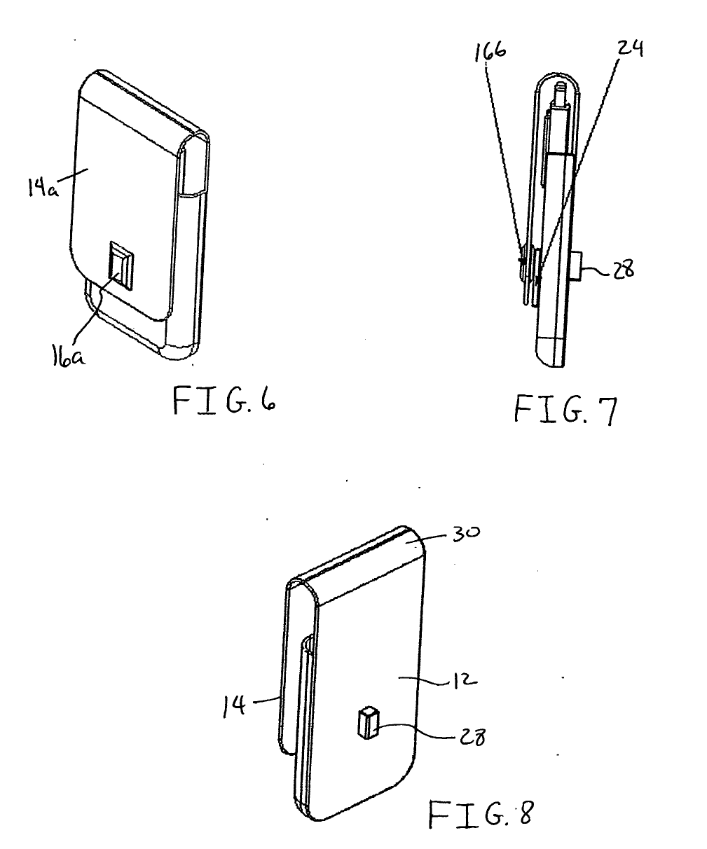

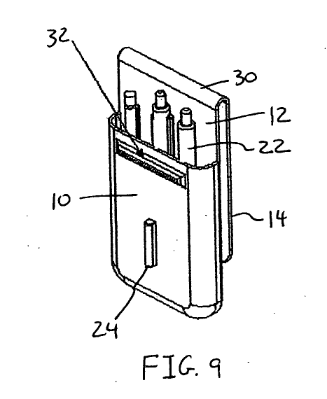

FIG. 3 shows the pouch of the present invention in the open position. In this configuration, the extension 14 folds back and would be inserted into the pocket of the clothing item. The magnet 16 attached to the extension would engage magnet 28 through the material of the clothing item pocket as shown in FIG. 4. FIG. 5 shows the backside 12 of the pouch that inserts into the pocket of the clothing item. The pouch of the present invention would be suspended outside the clothing item pocket. In conventional designs, this external suspension would cause much tension and stress on the clothing item pocket material to support the weight of the pouch the instruments in the pouch. Much of the stress would be on the upper portion of the clothing item pocket. With the present invention, the magnets engage at the lower portion of the clothing item pocket. The lower or bottom of the pocket is attached to the clothing item with some form of stitching or other attachment means. The attachment serves as a form of re-enforcement. Engagement at this location places much of the stress at the re-enforcement area of the pocket, which is better suited to support the weight of the pouch and instruments. In addition, engagement of the extension to the backside of the pouch helps to stabilize the pouch such that there is less movement of the pouch and therefore less stress on the pocket. Referring again to FIG. 3, the present invention can have side ends 34 and 36 that attach the front and back sides of the pouch. These ends can be of the same material as the front and back sides.

FIGS. 6, 7 and 8 show the magnet pouch of the present invention in the closed position. As shown in FIG. 6, as the extension folds forward, if closes in the instruments contained in the pouch. The magnet 16 engages the magnet 22. FIG. 7 shows the folding of the extension over the pocket material of the clothing item. This engagement of the magnets through the pocket material of the clothing item secures the magnetic pouch to the pocket of the clothing item. FIG. 8 shows the backside of the pouch in this configuration. In this configuration, magnet 28 is not in use. In this embodiment, the pouch is contained inside the clothing item pocket. In this configuration, the clothing item pocket provides the support for the pouch, unlike in the open position configuration of the pouch. As a result, the concerns about the stresses on the pocket related to supporting the pouch are not present in the closed position configuration.

FIG. 9 is a front, top and side view of the magnetic pocket pouch of the present invention with the extend member in a back folded or open position and showing the horizontal magnet attached to the front side of the pocket pouch. This horizontal magnet 32 extends across the front side 10 of the pouch. As with the other magnets stitching can be used to attach the magnet to the front side of the pouch. This horizontal magnet serves to attach magnetic stored instruments to the front side of the pouch and thereby further secure these items in the pouch.

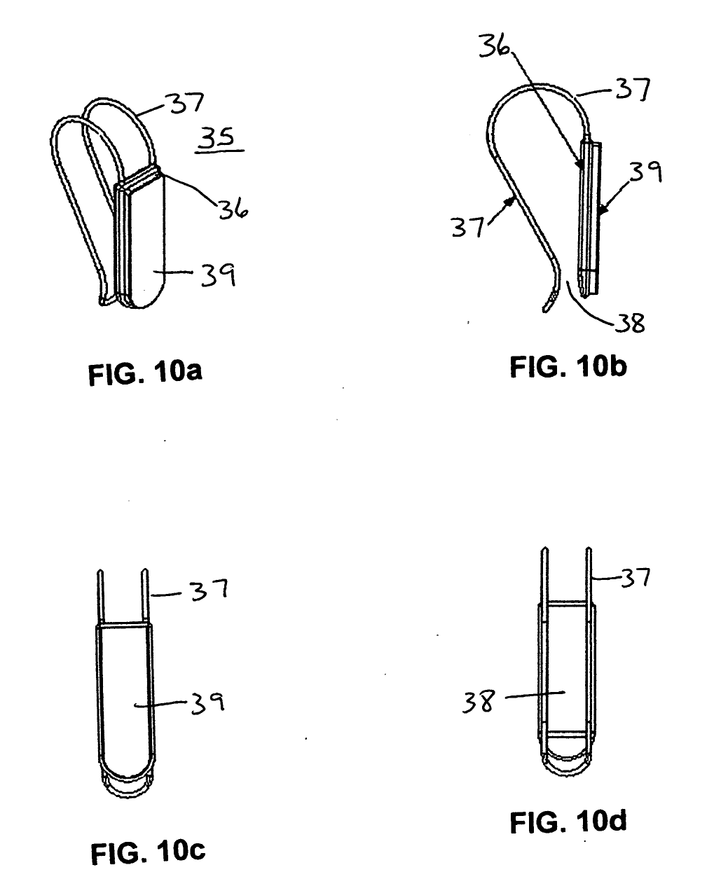

FIGS. 10a, 10b, 10c and 10d show a magnetic clip 35 that attaches to one of the external magnets of the pouch. FIG. 10a shows the three-quarter view of the clip. FIG. 10b shows the side view of the clip. FIGS. 10c and 10d show the back and front views of the clip respectively. This clip has a base 36 that attaches to an arm 37. The arm has a curved design with a contact area 38 that will engage and attach the clip and magnetic pouch to another object as desired. The base can have one or magnets 39 that attach to one of the external magnets 24 or 28. The base can also have a recess that can further facilitate the attachment of the base to the magnetic pouch. In another embodiment, the base 36 can be magnetic. In this embodiment, the additional magnets 39 are not necessary. The inclusion of the clip will enable the pouch to be attached to other objects such as a visor in a motor vehicle.

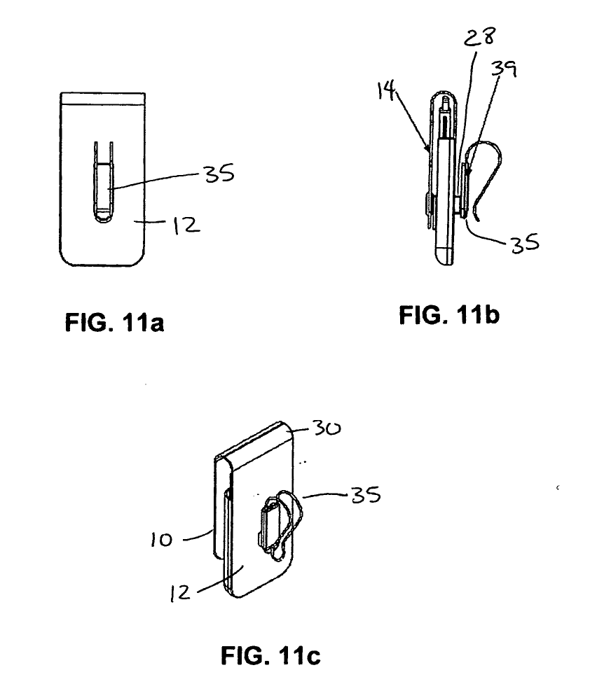

FIGS. 11a, 11b and 11c show back, side and three-quarter views of the magnetic clip attached to the magnetic pouch in the closed position. FIG. 11a shows the back view of the clip 35 attached to the pouch. FIG. 11b shows the side view of the clip 35 attached to the pouch. FIG. 11c shows a three-quarter view of the clip 35 attached to the pouch. As shown, the clip can attach to magnet 28. Although not shown, the clip 35 can also attach to magnet 16a on the extension when the pouch is in the closed position.

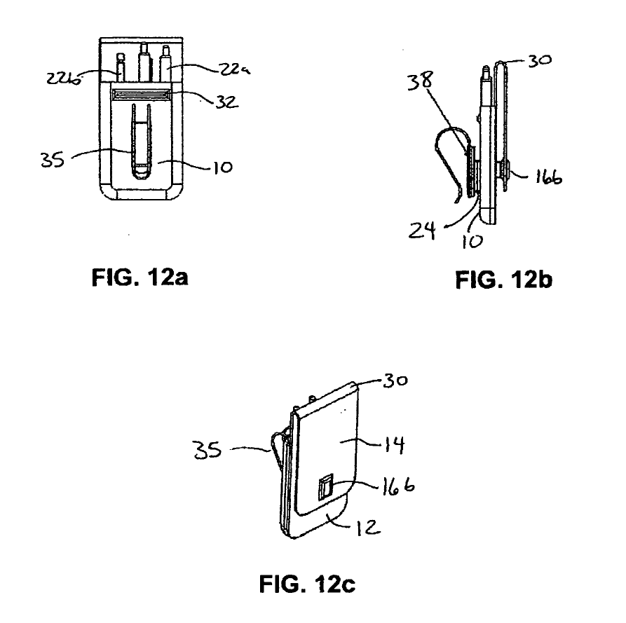

FIGS. 12a, 12b and 12c show front, side and three-quarter views of the magnetic clip attached to the magnetic pouch in the open position. FIG. 12a shows the front view of the clip 35 attached to the pouch. FIG. 12b shows the side view of the clip 35 attached to the pouch. FIG. 12c shows a three-quarter view of the clip 35 attached to the pouch. In this configuration, the clip 35 attaches to magnetic 24. Although not shown, the clip 35 can also attach to magnet 16b on the extension when the pouch is in the closed position.

The pocket pouch of the present invention provides significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention.

I claim:

1. A magnetic instrument holder device attachable to the pocket of an article of clothing worn by a person, the instrument holder device comprising:
a front side having a lower end, an upper end and two side ends;
a backside side a lower end, a lower upper end and two side ends, the side ends of said front side and backside being attached to each other to form a pocket;
an extension member attached to and extending upward from the upper end of said backside such that said extension is able to be folded forward or backward, said extension member having an inner side and an outer side;
an extension magnet attached to said extension member;
a front magnet attached to said front side of the instrument holder device; and
a back magnet, attached to said backside of the instrument holder device.

2. The magnetic instrument holder device as described in claim 1 further comprising a folder member attaching said back side and extension, the folder member positioned such that folding actions of the extension member will occur at the location of the folder member.

3. The magnetic instrument holder device as described in claim 1 wherein said front side, backside, extension and folder members are formed of a flexible and durable material.

4. The magnetic instrument holder device as described in claim 1 wherein said extension magnet further comprises a first magnet attached to the inner side of the extension for engaging said front side magnet when said extension is folded in a forward direction.

5. The magnetic instrument holder device as described in claim 4 wherein said extension magnet further comprises a second magnet attached to the outer side of the extension for engaging said back side magnet when said extension is folded in a backward direction.

6. The magnetic instrument holder device as described in claim 1 wherein each of said front, back and extension magnets is attached to the device with stitching.

7. The magnetic instrument holder device as described in claim 1 further comprising compartments formed in the pocket which is formed by the front side and back side of the device, the compartments providing distinct locations to store various types of instruments.

8. The magnetic instrument holder as described in claim 1 further comprising an instrument magnet attached to said front side, said instrument magnet being positioned on said from side above said front magnet, said instrument magnet being capable of securing instruments in the instrument holder device to the device.

9. The magnetic instrument holder device as described in claim 1 wherein said front magnet comprises at least a pair of magnets attached to said front side.

10. The magnetic instrument holder device as described in claim 3 wherein said front side, back side and extension are form of a leather material.

11. The magnetic instrument holder device as described in claim 3 wherein said front side, back side and extension are form of a leather material.

12. The magnetic instrument holder device as described in claim 3 wherein said folder member is comprise of a more durable material than the material that comprises said front side, back side and extension members.

13. The magnetic instrument holder device as described in claim 1 wherein said front side, back side and extension member comprise one piece, the one piece being folded such that said front side and back side have a common lower end and the ends of said front side and back side being attached to for a pocket.

14. The magnetic instrument holder device as described in claim 13 further comprising a folder member attaching said back side and extension, the folder member positioned such that folding actions of the extension member will occur at the location of the folder member.

15. The magnetic instrument holder device as described in claim 1 further comprising a pair of end members that attach said front side to said back side to form a pocket.

16. The magnetic instrument holder device as described in claim 1 further comprising a magnetic clip attached to the magnetic instrument holder at one of the front or back magnets of the magnetic instrument holder.

17. The magnetic instrument holder device as described in claim 8 further comprising a magnetic clip attached to the magnetic instrument holder at one of the front or back magnets of the magnetic instrument holder.
